(19) United States
(12) Patent Application Publication
(10) Pub. No.: US 2008/0102394 A1
(43) Pub. Date: May 1, 2008

(54) METHOD OF PREPARING RESIN COMPOSITION OF TONER AND TONER COMPOSITION HAVING THE SAME

(75) Inventors: Kyeong PANG, Uijeongbu-si (KR); Kyung-yol Yon, Seongnam-si (KR); Chang-kook Hong, Suwon-si (KR); Sang-eun Shim, Incheon (KR); Jeung-won Lee, Seoul (KR); Min-young Cheong, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/751,153

(22) Filed: May 21, 2007

(30) Foreign Application Priority Data
Oct. 31, 2006 (KR) 2006-106505

(51) Int. Cl. G03G 9/087; C08L 67/03

(52) U.S. Cl. 430/109.4; 525/319; 525/451

(57) ABSTRACT

A method of preparing a resin composition of a toner and a toner composition having the same. The method of preparing the resin composition includes preparing a compound in which a double bond is introduced into a polyester by reacting the polyester with a double bond-containing compound, adding a first vinyl-based monomer to the polyester having the double bond, and polymerizing the first vinyl-based monomer and the polyester having the double bond.

### CROSS-REFERENCE TO RELATED APPLICATIONS

This application claims priority under 35 U.S.C. § 119 (a) from Korean Patent Application No. 10-2006-0106505, filed on Oct. 31, 2006, in the Korean Intellectual Property Office, the disclosure of which is incorporated herein by reference in its entirety.

### BACKGROUND OF THE INVENTION

1. Field of the Invention

The present general inventive concept relates to a method of preparing a resin composition of a toner and a toner composition having the same. More particularly, the present general inventive concept relates to a method of preparing a resin composition of a toner and a toner composition having the same, in which a resin composition of a toner having desirable properties of a polyester-based monomer and a vinyl-based monomer is prepared, so that it is easy to control a structure and size of toner particles, and a toner composition having a high gloss, excellent durability, low-temperature fixing properties, and storage quality can be prepared using the resin composition.

2. Description of the Related Art

Toners are a type of recording materials used in image forming apparatuses to form images on recording media. Toners are classified as monochrome toners to form monochrome images and full color toners to form color images.

Various conventional toner preparation methods are known for preparing a composition having a toner, but briefly, toners are generally prepared by mixing a binder resin, a colorant, and a wax, followed by pulverizing the mixture, and classifying toner particles according to a particle size. General details pertaining to a conventional toner preparation method are described in detail below:
1) Kneading or extruding: kneading the mixture including a binder resin, a colorant, and a wax
2) Fine grinding or pulverizing
3) Classifying: separating particles according to their size
4) Processing with an external additive: adding an external additive to the toner particles in order to provide fluidity of toner particles and charge stability

If toner particles are prepared which are suitable for image formation using an electrophotographic method or an electrostatic latent image record method, it is difficult to precisely control a size and geometric size distribution of the toner particles, and only a toner shape can be controlled in a conventional pulverizing process. Additionally, if a toner particle having a small particle size (approximately 5 μm to approximately 8 μm) is prepared, the yield of the prepared toner is remarkably reduced due to the classifying process. In other words, it is necessary to classify pulverized particles in order to adjust the size of the toner particles, but if toner particles having a small particle size are classified, the yield of the toner particle is remarkably reduced and it is difficult to control the toner shape.

Accordingly, a toner prepared according to the above-described conventional method has limitations regarding modification and control of a toner structure in order to increase fixing properties, such as low-temperature fixing or temporary fixing.

A method of preparing a polymerized toner by a suspension or emulsion/flocculation technique, as described below, overcomes the above problems. A polymerized toner is referred to as a chemically prepared toner (CPT) and is prepared by the following method:
1) Polymerizing a resin: including a wax
2) Flocculating: including a pigment
3) Washing and drying
4) Adding an external additive

In a case of preparing a polymerized toner, toner particles having a desired size can be obtained without the classifying process necessary for a pulverizing toner preparation process, and a particle shape can be freely controlled to readily obtain a toner with a narrow geometric size distribution.

A suspension polymerization technique is performed to polymerize a polymer latex using water as a dispersion medium, a water-insoluble monomer, and a hydrophobic initiator in the presence of a polymer stabilizer.

On the other hand, an emulsion polymerization technique has been widely used as a method usable for preparing particles with a uniform geometric size distribution. Generally, the emulsion polymerization technique is performed in an aqueous phase to polymerize a latex using a hydrophobic monomer, which is insoluble in water, and a hydrophilic polymerization initiator, and to prepare particles. Using the emulsion/flocculation technique, a size and shape of the toner particles may be easily controlled, and toner particles may have a high transcriptional efficiency when forming an image.

When a toner is prepared using a polymerization technique, polymerizable monomers, such as styrene monomers, used as resins for a toner particle are generally used, but polyester-based monomers are used less frequently.

This is because it is difficult to dissolve polyester-based monomers in a solvent and to polymerize polyester-based monomers in a solution, even though polyester-based monomers have an effect capable of providing a high gloss and a high particle uniformity to the polymerized toner. Therefore, polyester-based monomers are mainly used for pulverizing the toner.

Accordingly, this polymerization technique is used to prepare a toner with superior quality compared to a toner prepared using the pulverization technique. However, the polymerization technique has a problem that it is not easy to use polyester-based monomers, even though they have excellent characteristics as raw materials of the toner. Accordingly, a method is required to effectively use a polyester-based monomer exhibiting excellent characteristics during toner preparation for a method to prepare a polymerized toner.

### SUMMARY OF THE INVENTION

The present general inventive concept provides a method of preparing a resin composition of a toner and a toner composition having the same, in which a resin composition of a toner having excellent properties of a polyester-based monomer and a vinyl-based monomer is prepared, so that it is easy to control a structure and size of toner particles, and a toner composition having a high gloss, excellent durability, low-temperature fixing properties, and storage quality can be prepared using the resin composition.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of preparing a resin composition of a toner, the method including preparing a compound to introduce a double bond into a polyester by reacting the polyester with a double bond-containing compound, adding a first vinyl-based monomer to the polyester having the double bond, and polymerizing the first vinyl-based monomer and the polyester having the double bond.

The polyester may comprise a hydroxyl group at the chain end, have a molecular weight of approximately 1,000 to approximately 100,000, and a glass transition temperature of approximately 40° C. to approximately 80° C. The polyester may be a polyethylene terephthalate (PET).

The double bond may be a vinyl-based double bond.

The preparing of the compound may include sequentially adding a compound containing a diisocyanate group and a second vinyl-based monomer containing a second double bond.

The diisocyanate group-containing compound may be one of hexamethylene diisocyanate, isophorone diisocyanate, methylene biscyclohexyl isocyanate, toluene diisocyanate, methylene bisphenyl isocyanate, and a mixture thereof.

The second vinyl-based monomer may be one of an acrylamide-based monomer, such as, an acrylamide, a methacrylamide and a hydroxymethyl acrylamide; a hydroxyacrylate-based monomer, such as, hydroxymethyl acrylate, hydroxyethyl acrylate, hydroxyethyl methacrylate, hydroxymethyl methacrylate, hydroxyphenoxypropyl acrylate, hydroxypropyl acrylate and hydroxypropyl methacrylate; and an arylamine-based monomer.

The double bond-containing compound may be a silane coupling agent.

The foregoing and/or other aspects and utilities of the present general inventive concept may also be achieved by providing a toner composition including a resin composition prepared by preparing a compound in which a double bond is introduced into a polyester by reacting the polyester with a double bond-containing compound, adding a first vinyl-based monomer to the polyester having the double bond, and polymerizing the first vinyl-based monomer and the polyester having the double bond, and a colorant.

The toner composition may further include a release agent, and a charge controller.

The foregoing and/or other aspects and utilities of the present general inventive concept may also be achieved by providing a toner composition including a resin composition having a polymerized first vinyl-based monomer and a polyester having a double bond, and a colorant.

The polyester having the double bond can be made from a compound and a second vinyl-based monomer containing a second double bond.

The compound may contain a diisocyanate group, and the second vinyl-based monomer may contain a second double bond.

The foregoing and/or other aspects and utilities of the present general inventive concept may also be achieved by providing a method of preparing a resin composition of a toner, the method including reacting a double bond-containing compound to a polyester to introduce a double bond to the polyester, adding a first vinyl-based monomer to the polyester having the double bond, and polymerizing the first vinyl-based monomer and the polyester having the double bond.

The double bond-containing compound can be prepared by sequentially adding a compound containing a diisocyanate group and a second vinyl-based monomer containing a double bond.

The double bond-containing compound can be capable of introducing a reactor having a double bond to polymerize at a chain end of the polyester.

The double bond can be a vinyl-based double bond-containing compound.

The double bond-containing compound can be a silane coupling agent.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A illustrates H-NMR spectra of a polyethylene terephthalate (PET) used in Example 1;

FIG. 1B illustrates H-NMR spectra of a polyethylene terephthalate (PET) having a double bond prepared as Example 1 according to an embodiment of the present general inventive concept;

FIG. 2A illustrates H-NMR spectra of a polyethylene terephthalate (PET) used in Example 2; and

FIG. 2B illustrates H-NMR spectra of a polyethylene terephthalate (PET) having a double bond prepared as Example 2 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

According to an exemplary embodiment of the present general inventive concept, a method of preparing a resin composition of a toner may include a compound in which a double bond is introduced into a polyester by reacting a polyester with a double bond-containing compound, and adding a first vinyl-based monomer to the polyester having a double bond, and polymerizing the first vinyl-based monomer and the polyester having the double bond.

Polyester is a polymer having an ester bond (—COO—) at the main chain. Polyester itself is a polymer generated by polymerizing monomers, but in an exemplary embodiment of the present general inventive concept, the polyester is used as a type of monomer which is polymerized with a first vinyl-based monomer in order to be used in a polymerized toner preparation method. Any polyester usable in a toner may be used as the polyester in this exemplary embodiment of the present general inventive concept.

As described above, the polyester monomer may be a monomer which is not used frequently in the polymerized toner preparation method, as it is normally difficult to dissolve polyester monomers in a solvent and to polymerize polyester monomers in a solution, even though polyester monomers have an effect capable of providing a high gloss and a high particle modulus to toner particles.

Accordingly, in order to use the polyester in the preparation of a toner composition using the polymerized toner preparation method, this exemplary embodiment of the present general inventive concept uses a method of introducing a double bond. In the method of preparing a resin composition of a toner according to this exemplary embodiment of the present general inventive concept, the polyester is first reacted with a double bond-containing compound.

The polyester, as a reactor necessary to introduce the double bond, may include a hydroxyl group at a chain end. The polyester, as a polymerized monomer of a resin composition of a polymerized toner, may have a molecular weight of approximately 1,000 to approximately 100,000 and a glass transition temperature of approximately 40° C. to approximately 80° C.

Additionally, the polyester may be polyethylene terephthalate (PET). PET generally refers to a saturated polyester which can be obtained by polycondensing an ethylene glycol with a terephthalic acid.

Any compound capable of introducing a double bond into a polyester may be used as the double bond-containing compound, and particularly, a compound capable of introducing a reactor having a double bond to polymerize at the chain end of the polyester may be used because polymerization can be performed during a resin composition preparation.

The double bond may be a vinyl-based double bond. The polyester having a double bond can be polymerized with a styrene-based monomer to obtain a resin composition exhibiting advantages of polyester and styrene, and thus, the above-described double bond may be a vinyl-based double bond which can be polymerized with a vinyl group of the styrene-based monomer.

In the method of preparing a resin composition of a toner according to the above exemplary embodiment of the present general inventive concept, the preparing of a compound into which a double bond is introduced into a polyester may include sequentially adding a compound containing a diisocyanate group, and a second vinyl-based monomer containing a double bond.

For Example, to introduce a double bond into a polyester, the diisocyanate group-containing compound can be first reacted with the polyester, and an isocyanate group is introduced into the chain end of the polyester. The polyester containing the isocyanate group at the chain end is again reacted with the second vinyl-based monomer which is a compound having a vinyl group. The isocyanate group of the polyester is substituted with the vinyl group of the second vinyl-based monomer, and therefore, the vinyl group is introduced into the end of the polyester and the polyester has the double bond.

One example of the method of introducing a double bond into a polyester as described above is represented by the following reaction scheme 1. In the reaction scheme 1, polyethylene terephthalate (PET) is used as a polyester. However, the present general inventive concept is not limited thereto, and other suitable polyesters may be used.

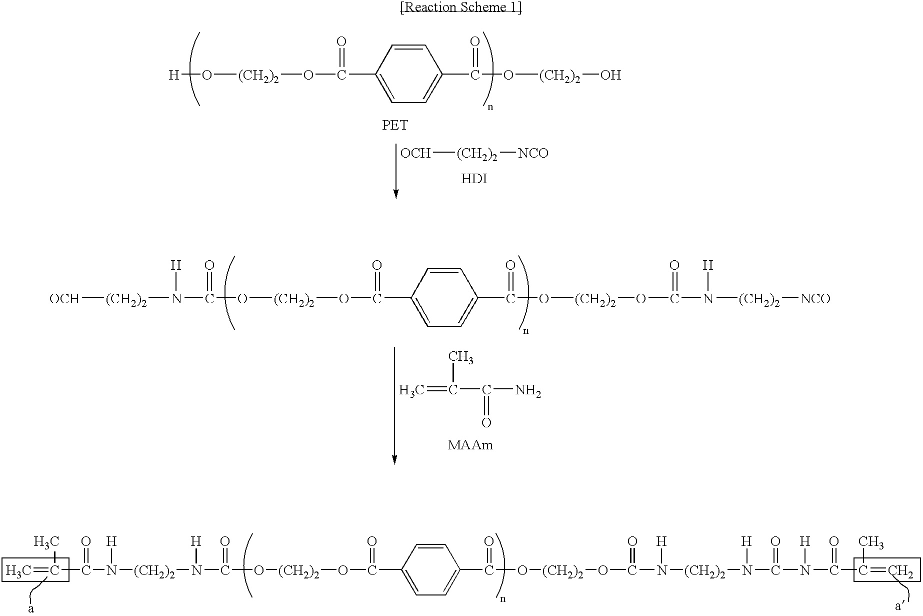

The PET used as a polyester in the reaction scheme 1 is reacted with hexamethylene diisocyanate (HDI), and accordingly, the PET includes an isocyanate group instead of a hydroxyl group at the chain end.

In this case, methacrylamide (MAAm) is added thereto as a second vinyl-based monomer, and the isocyanate group of the PET is substituted with a vinyl group at the chain end of the MAAm. Accordingly, the PET includes the vinyl groups (a and a′) derived from the MAAm at each chain end, and a PET into which a vinyl-based double bond is introduced is obtained.

The diisocyanate group-containing compound may be one of hexamethylene diisocyanate, isophorone diisocyanate, methylene biscyclohexyl isocyanate, toluene diisocyanate, methylene bisphenyl isocyanate, and a mixture thereof.

The second vinyl-based monomer for introducing the vinyl group into each chain end of the polyester may be one of an acrylamide-based monomer, such as, an acrylamide, a methacrylamide and a hydroxymethyl acrylamide; a hydroxyacrylate-based monomer, such as, hydroxymethyl acrylate, hydroxyethyl acrylate, hydroxyethyl methacrylate, hydroxymethyl methacrylate, hydroxyphenoxypropyl acrylate, hydroxypropyl acrylate and hydroxypropyl methacrylate; and an arylamine-based monomer.

In the method of preparing a resin composition of a toner according to the above exemplary embodiment of the present general inventive concept, the double bond-containing compound which is reacted with the polyester may be a silane coupling agent.

Examples of the silane coupling agent may include an amino-based silane coupling agent, an epoxy-based silane coupling agent, an acryl-based silane coupling agent, a vinyl-based silane coupling agent, or other silane coupling agents. The amino-based silane coupling agent includes an organic functional group, including an amino group, and a hydrolyzable group, such as an alkoxy group. The epoxy-based, acryl-based, vinyl-based, or other silane coupling agents include a hydrolyzable group, such as an alkoxy group, and an organic functional group, such as, an acrylic group, an epoxy group, a vinyl group, and a mercapto group. Therefore, the silane coupling agents can facilitate the bonding of an organic material, such as a resin, and an inorganic material, such as, silica, glass, metal or other materials, and accordingly make it possible to improve properties of the materials.

The silane coupling agent may include the vinyl-based double bond, and accordingly, may be a vinyl-based silane coupling agent.

One example of the method of introducing a double bond into the polyester using the silane coupling agent having the double bond as described above is represented by the following reaction scheme 2. In the reaction scheme 2, polyethylene terephthalate (PET) is used as a polyester.

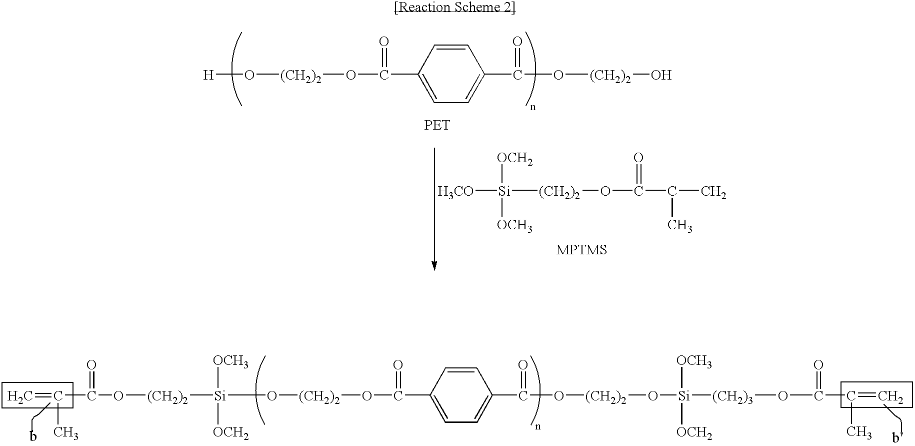

In reaction scheme 2, the PET is reacted with methacryloxypropyltrimethoxysilane (MPTMS) which is a silane coupling agent, and thus, the PET includes vinyl groups (b and b′) instead of a hydroxyl group at the chain end.

If a double bond is introduced into the PET, the first vinyl-based monomer is added thereto, and the mixture is then polymerized.

As the first vinyl-based monomer, any monomer polymerizable with the polyester having a double bond may be used. The first vinyl-based monomer may be a styrene-based monomer, an acrylate-based monomer, and a methacrylate-based monomer.

The above-described polyester having a double bond, as a kind of monomer, may be a macromonomer. In the exemplary embodiments of the present general inventive concept, the term “macromonomer” refers to a polymer in which at least one functional group having reactivity at the chain end is substituted. The macromonomer serves as a monomer in polymerization reaction of other polymers, and accordingly, a hybrid resin, which has a structure in which chains of two types of polymers having different characteristics are bonded chemically, can be produced.

When the above hybrid resin is used, two different types of polymers exist during toner preparation. Accordingly, properties of different polymers may be combined. Additionally, since two types of polymers are chemically bonded, chemical, mechanical, and thermal characteristics can improve resulting from an increase in compatibility.

A polymerization initiator may be added in order to polymerize the polyester and first vinyl-based monomer. The polymerization initiator, as an additive, is added to initiate the polymerization of the monomer. As the polymerization initiator, any polymerization initiator capable of polymerizing the polyester and first vinyl-based monomer may be used, and particularly, a radical polymerization initiator may be used. For example, potassium persulfate may be used.

According to another exemplary embodiment of the present general inventive concept, a toner composition may include a resin composition and a colorant. The resin composition is prepared by a method of preparing a resin composition of a toner, and may include preparing a compound in which a double bond is introduced into a polyester by reacting the polyester with a double bond-containing compound, adding a first vinyl-based monomer to the polyester having a double bond, and polymerizing them.

Colorants embody colors of toner particles and can be classified as dye-based colorants and pigment-based colorants. Generally, any colorant which is widely used may be used as the colorant of this exemplary embodiment.

Examples of pigment-based colorants usable in the toner composition according to this exemplary embodiment may include azo-based pigments, phthalocyanine-based pigments, basic dye-based pigments, quinacridone-based pigments, dioxazine-based pigments, condensed azo-based pigments, chromates, ferrocyanides, oxides, sulfides, selenides, sulfates, silicates, carbonates, phosphates, metal powder, and carbon black, but the present general inventive concept is not limited thereto.

The toner composition according to this exemplary embodiment of the present general inventive concept may further include a release agent and a charge controller.

The release agent is an additive to prevent toner offset. A wax may be used as the release agent. Examples of the wax usable in this exemplary embodiment may include polyethylene, polypropylene, ester, a carnauba wax, or the like, but are not necessarily limited thereto.

The charge controller can be added in order to control the quantity of electrical charge, charged to toner particles, and can be referred to as a charge regulator or an electrification regulating agent. Additionally, the types of charge controlling agent to be added differ according to the electrical charge of the toner particles (positive charge (+) or negative charge (−)).

Additionally, an external additive, such as silica, can be added to dried toner particles to control the charge amount and other properties. Finally, a dry toner is prepared.

### EXAMPLES

Hereinafter, a resin composition of a toner is prepared using a polyester-based monomer and a vinyl-based monomer according to the above exemplary embodiments of the present general inventive concept, and a toner composition is prepared using the prepared resin composition. It will be apparent to those skilled in the art that the description of the exemplary embodiments of the present general inventive concept is intended to be illustrative of the preparation of a resin composition of a toner and a toner composition, but not to limit the preparation method performed in this manner.

### <Preparation of Polyester Having Double Bond>

### Example 1

1 g of polyethylene terephthalate (PET), as a polyester, was dissolved in 50 ml of a methyl ethyl ketone (MEK) solvent, and then 0.12 g of hexamethylene diisocyanate (HDI) was added thereto. The reaction mixture was reacted at 65° C. for 6 hours to synthesize a PET, as a polyester having both ends substituted with isocyanate.

0.05 g of methacrylamide was added thereto, and the mixture was reacted at 25° C. for 24 hours to synthesize a PED-macromonomer having both ends substituted with a vinyl-based unsaturated hydrocarbon (double bond). At this time, in order to prevent a side reaction caused by a reaction of isocyanate and OH group, a small amount of dibutyltin dilaurate (DBTDL) was added thereto.

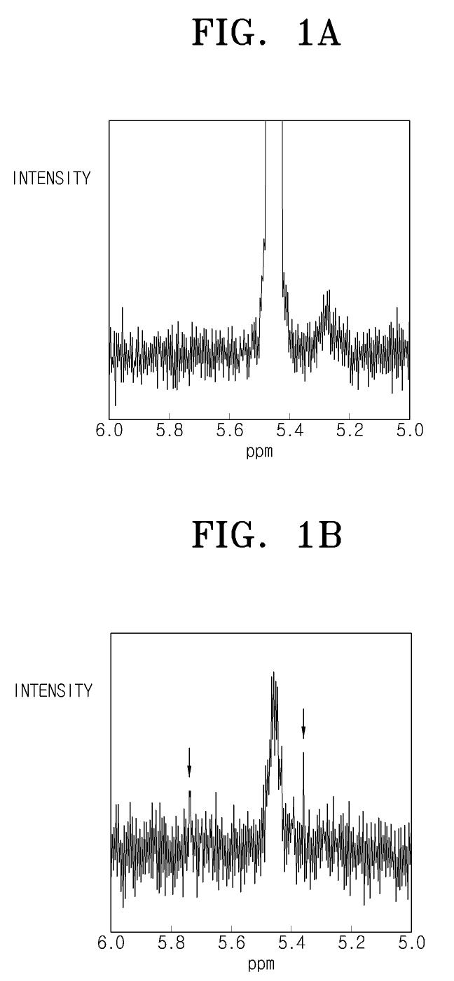

FIG. 1A illustrates H-NMR spectra of the PET used in Example 1. The PET was analyzed using H-NMR spectra before the PET was reacted.

FIG. 1B illustrates H-NMR spectra of the PET having a double bond prepared in Example 1.

When comparing FIG. 1A with FIG. 1B, in the case of the PET having a double bond as illustrated in FIG. 1B, peaks in numbers of protons of vinyl group located at each chain end of the PET were observed at positions indicated by arrows corresponding to approximately 5.4 and approximately 5.8 ppm, respectively, illustrating that the vinyl group exists. On the other hand, in the case of the pure PET as illustrated in FIG. 1A, there was no peak indicating the vinyl group.

Therefore, in the exemplary embodiment of the present general inventive concept of Example 1, a PET having a vinyl-based double bond was prepared.

### Example 2

1 g of polyethylene terephthalate (PET), as a polyester, was dissolved in 50 ml of toluene, and then 0.18 g of methacryloxypropyltrimethoxysilane (MPTMS) as a silane coupling agent, was added thereto. The reaction mixture was reacted at 70° C. for 24 hours.

At this time, the reaction to introduce a double bond of the MPTMS into the PET can be performed at a normal temperature. Additionally, in order to prevent the loss of the double bond of the MPTMS caused by polymerizing the MPTMS at a high temperature, a small amount of hydroquinone can be added thereto at a temperature of 50° C. or higher.

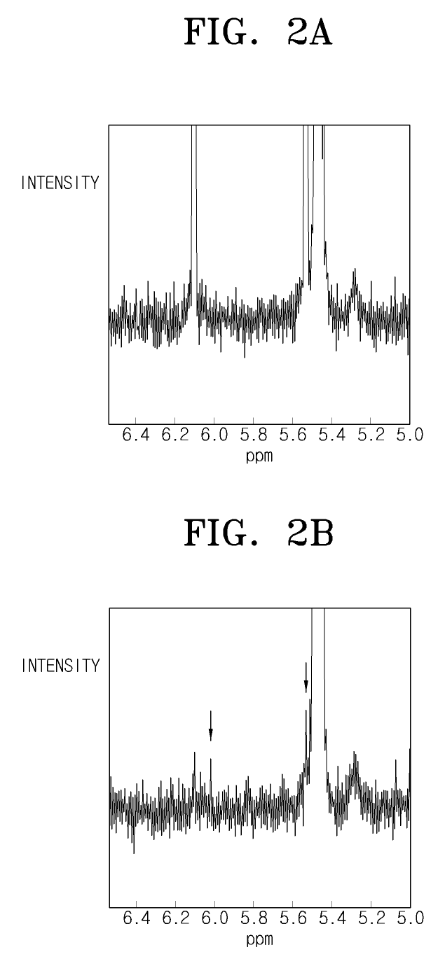

FIG. 2A illustrates H-NMR spectra of the PET used in Example 2. The PET was analyzed using H-NMR spectra before the PET was reacted.

FIG. 2B illustrates H-NMR spectra of the PET having a double bond prepared in Example 2.

When comparing FIG. 2A with FIG. 2B, in the case of the PET having a double bond as illustrated in FIG. 2B, peaks in the numbers of protons of the vinyl group located at each chain end of the PET were observed at positions indicated by arrows corresponding to approximately 5.5 and approximately 6.0 ppm, respectively, illustrating that the vinyl groups exist. On the other hand, in the case of the pure PET, as illustrated in FIG. 2A, there were no peaks to indicate the vinyl groups.

Therefore, in the exemplary embodiment of the present general inventive concept of Example 2, a PET having a vinyl-based double bond was prepared.

### <Preparation of Resin Composition of Toner, and Preparation of Toner Composition Using the Prepared Resin Composition>

The PET having a double bond obtained in Examples 1 and 2 was mixed with a styrene-based monomer in a reactor. After the resulting mixture was heated to 70° C. while pursing with nitrogen gas, 0.1 g of potassium persulfate (KPS) as a polymerization initiator was added thereto, and then the mixture was stirred at 350 rpm for 24 hours to obtain a resin composition of a toner.

The above resin composition of a toner was a hybrid resin composition polymerized with the styrene-based monomer. Then, a colorant, a release agent, and a charge controller were added to the resin composition to control a shape and size thereof. The mixture was cooled to a glass transition temperature or lower. A solution containing toner particles thus formed was filtered, separated, and dried. External additives, such as silica, were added externally to the dried toner particles to control the charge amount, and as a result, a toner composition was prepared.

As described above, in the method of preparing a resin composition of a toner according to exemplary embodiments of the present general inventive concept, a resin composition of a toner having excellent properties of polyester-based and vinyl-based monomers can be prepared. If the prepared resin composition is used, it is easy to control a structure and shape of toner particles and it is possible to prepare a toner composition which exhibits high gloss, excellent durability, low-temperature fixing properties, and storage quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of preparing a resin composition of a toner, the method comprising:
preparing a compound to introduce a double bond into a polyester by reacting the polyester with a double bond-containing compound;
adding a first vinyl-based monomer to the polyester having the double bond; and
polymerizing the first vinyl-based monomer and the polyester having the double bond.

2. The method of claim 1, wherein the polyester comprises a hydroxyl group at the chain end.

3. The method of claim 1, wherein the polyester has a molecular weight of approximately 1,000 to approximately 100,000.

4. The method of claim 1, wherein the polyester has a glass transition temperature of approximately 40° C. to approximately 80° C.

5. The method of claim 1, wherein the polyester is a polyethylene terephthalate (PET).

6. The method of claim 1, wherein the double bond is a vinyl-based double bond.

7. The method of claim 1, wherein the preparing of the compound comprises sequentially adding a compound containing a diisocyanate group and a second vinyl-based monomer containing a second double bond.

8. The method of claim 7, wherein the diisocyanate group-containing compound is selected from a group consisting of hexamethylene diisocyanate, isophorone diisocyanate, methylene biscyclohexyl isocyanate, toluene diisocyanate, methylene bisphenyl isocyanate, and a mixture thereof.

9. The method of claim 7, wherein the second vinyl-based monomer is selected from a group consisting of an acrylamide-based monomer, a hydroxyacrylate-based monomer, and an arylamine-based monomer.

10. The method of claim 9, wherein the acrylamide-based monomer, comprises one of an acrylamide, a methacrylamide, and a hydroxymethyl acrylamide and is used as the second vinyl-based monomer.

11. The method of claim 9, wherein the hydroxyacrylate-based monomer comprises one of hydroxymethyl acrylate, hydroxyethyl acrylate, hydroxyethyl methacrylate, hydroxymethyl methacrylate, hydroxyphenoxypropyl acrylate, hydroxypropyl acrylate, and hydroxypropyl methacrylate and is used as the second vinyl-based monomer.

12. The method of claim 1, wherein the double bond-containing compound is a silane coupling agent.

13. A toner composition, comprising:
a resin composition prepared by preparing a compound in which a double bond is introduced into a polyester by reacting the polyester with a double bond-containing compound, adding a first vinyl-based monomer to the polyester having the double bond, and polymerizing the first vinyl-based monomer and the polyester having the double bond; and
a colorant.

14. The toner composition of claim 13, further comprising:
a release agent; and
a charge controller.

15. A toner composition comprising:
a resin composition having a polymerized first vinyl-based monomer and a polyester having a double bond; and
a colorant.

16. The toner composition of claim 15, wherein the polyester having the double bond is made from a compound and a second vinyl-based monomer containing a second double bond.

17. The toner composition of claim 16, wherein the compound contains a diisocyanate group, and the second vinyl-based monomer contains a second double bond.

18. The method of claim 1, wherein the double bond-containing compound is capable of introducing a reactor having a double bond to polymerize at a chain end of the polyester.
